(19) United States
(12) Patent Application Publication
(10) Pub. No.: US 2012/0044277 A1
(43) Pub. Date: Feb. 23, 2012

(54) BRIGHTNESS CONTROL APPARATUS AND BRIGHTNESS CONTROL METHOD

(75) Inventor: Takeshi ADACHI, Saitama (JP)

(73) Assignees: ATRC CORPORATION, Saitama (JP); MITSUMI ELECTRIC CO., LTD., Tokyo (JP)

(21) Appl. No.: 13/213,206

(22) Filed: Aug. 19, 2011

(30) Foreign Application Priority Data
Aug. 23, 2010 (JP) 2010-186368

(51) Int. Cl. G09G 5/10

(52) U.S. Cl. 345/690; 345/102

(57) ABSTRACT

A brightness control apparatus for performing brightness control on backlights for a display screen based on an input image signal, includes: an image information analysis unit configured to analyze information of at least one item of an average brightness level, brightness histogram information, color histogram information and frequency histogram information that are obtained from an image frame included in the image signal; a block information obtaining unit configured to divide the image frame into blocks and to obtain image information for each of the blocks based on an analysis result of the image information analysis unit; a brightness correction unit configured to perform brightness correction on backlights corresponding to each of the blocks divided by the block information obtaining unit; and a backlight driving control unit configured to perform driving control of the backlights for each of the blocks based on correction information obtained by the brightness correction unit.

### CROSS-REFERENCE TO RELATED APPLICATION

The present application is based upon and claims the benefit of priority of Japanese Patent Application No. 2010-186368, filed on Aug. 23, 2010, the entire contents of which are incorporated herein by reference.

### BACKGROUND OF THE INVENTION

1. Field of the Invention

The present invention relates to a brightness control apparatus and a brightness control method. More specifically, the present invention relates to a brightness control apparatus and a brightness control method for displaying a video or an image that is optimal for a user on a display apparatus, and for realizing effective power consumption reduction.

2. Description of the Related Art

In technical fields of various display apparatuses for displaying pictures or images, enhancement of image quality and improvement of power consumption and the like are being studied. Researches on the technical field can be referred to Japanese Laid-Open Patent Applications No. 2009-294637, No. 2009-109975 and No. 2007-183639, for example. Also, as recent display apparatuses, especially, liquid crystal displays (LCD) are commonly used.

In general, the LCD is configured to include an output panel for displaying an image using light and a backlight unit for emitting light. The backlight unit is designed mainly for the purpose of providing light evenly to an effective display area of the output panel on which the image is displayed.

Also, conventionally, control apparatuses (for example, contents analyzer) for controlling the backlight unit are known. Generally, in these control apparatuses, backlight control is performed by using simple APL (Average Picture Level (average brightness level)) detection. Also, it is known that brightness control is performed linearly using APL information of an image signal when controlling brightness of backlight of the LCD panel.

However, the backlight control by the APL detection of the above-mentioned conventional technique cannot operate optimally for image contents. For example, the same control operation is performed for information of APL 50% including many black components and information of API, 50% including many white components. Thus, there is a problem in that overexposure and underexposure often occur.

Also, in general, the backlight unit is placed on the back surface of the LCD panel, and brightness control operates in units of blocks for dimming. However, since the operation of the backlight is brightness operation of low resolution less than the resolution of the image signal, there occurs a difference between brightness resolutions of the backlight and the image signal. This causes so-called “backlight brightness interference”. Especially, this phenomenon often occurs at a part where brightness change is large.

Further, like the conventional method, when linear control based on APL for backlight brightness is performed, although power consumption can be decreased, a side effect that a contrast decrease occurs due to linear control.

### SUMMARY OF THE INVENTION

Accordingly, an object of the present invention is to provide a brightness control apparatus and a brightness control method for displaying an optimal image or video for a user and for realizing effective reduction of power consumption in a display apparatus and the like.

According to an embodiment of the present invention, there is provided a brightness control apparatus for performing brightness control on backlights for a display screen based on an input image signal, including:

an image information analysis unit configured to analyze information of at least one item of an average brightness level, brightness histogram information, color histogram information and frequency histogram information that are obtained from an image frame included in the image signal;

a block information obtaining unit configured to divide the image frame into blocks and to obtain image information for each of the blocks based on an analysis result of the image information analysis unit;

a brightness correction unit configured to perform brightness correction on backlights corresponding to each of the blocks divided by the block information obtaining unit; and

a backlight driving control unit configured to perform driving control of the backlights for each of the blocks based on correction information obtained by the brightness correction unit.

According to another embodiment of the present invention, there is provided a brightness control method for performing brightness control on backlights for a display screen based on an input image signal, including:

an image information analysis step of analyzing information of at least one item of an average brightness level, brightness histogram information, color histogram information and frequency histogram information that are obtained from an image frame included in the image signal;

a block information obtaining step of dividing the image frame into blocks and obtaining image information for each of the blocks based on an analysis result of the image information analysis step;

a brightness correction step of performing brightness correction on backlights corresponding to each of the blocks divided by the block information obtaining step; and

a backlight driving control step of performing driving control of the backlights for each of the blocks based on correction information obtained by the brightness correction step.

Other objects and further features of the present invention will be apparent from the following detailed description when read in conjunction with the accompanying drawings.

### BRIEF DESCRIPTION OF THE DRAWINGS

FIG. 1 is a diagram showing an example of a functional configuration of a brightness control apparatus in a first embodiment;

FIG. 2 is a schematic flowchart showing an example of a brightness control process procedure in the present embodiment;

FIGS. 3A and 3B are diagrams showing examples of block configurations of light-emitting elements that can be applied in the present embodiment;

FIGS. 4A-4C are diagrams for explaining outline configurations of the backlight driving control unit;

FIG. 5 is a diagram showing a configuration example of the backlight driving control unit of the present embodiment;

FIG. 6 is a diagram showing an example of a functional configuration of a brightness control apparatus in a second embodiment;

FIG. 7 is a diagram showing an example of a functional configuration of a brightness control apparatus in a third embodiment;

FIGS. 8A-8C are diagrams showing examples of correction patterns in brightness correction;

FIG. 8D is a diagram showing an example of a procedure for block dimming processing;

FIG. 9A is a diagram showing an example of a setting screen of APL;

FIG. 9B is a diagram showing an example of a setting screen of a brightness histogram;

FIG. 9C is a diagram showing an example of a setting screen of a hue histogram;

FIG. 9D is a diagram showing an example of a setting screen of a color saturation histogram;

FIG. 9E is a diagram showing an example of a setting screen of a frequency histogram;

FIG. 10 is a diagram for explaining a concrete example of optimal dynamic backlight control in the present embodiment;

FIG. 11 is a diagram for explaining non-linear control and offset control for backlight brightness in the present embodiment; and

FIG. 12 is a diagram for explaining a concrete example of dimming block interference prevention in the present embodiment.

### DESCRIPTION OF THE PREFERRED EMBODIMENTS

Preferred embodiments of the present invention are described below with reference to the accompanying drawings.

### Outline of Embodiment

According to an embodiment of the present invention, a brightness control apparatus (10, 60, 70) for performing brightness control on backlights for a display screen based on an input image signal is provided. The brightness control apparatus includes:

an image information analysis unit (12) configured to analyze information of at least one item of an average brightness level, brightness histogram information, color histogram information and frequency histogram information that are obtained from an image frame included in the image signal;

a block information obtaining unit (13) configured to divide the image frame into blocks and to obtain image information for each of the blocks based on an analysis result of the image information analysis unit;

a brightness correction unit (17, 62) configured to perform brightness correction on backlights corresponding to each of the blocks divided by the block information obtaining unit; and

a backlight driving control unit (15) configured to perform driving control of the backlights for each of the blocks based on correction information obtained by the brightness correction unit.

According to the brightness control apparatus, an optimal image that a user can easily watch can be displayed on a display screen, and power consumption can be reduced efficiently.

In the brightness control apparatus, the brightness correction unit (17, 62) performs offset correction and/or non-linear correction for a brightness value of the backlights based on the analysis result obtained by the image information analysis unit.

The brightness control apparatus may further include an image correction unit (71, 72, 73) configured to perform correction for the image signal based on brightness correction information for the backlights that is obtained by the brightness correction unit.

Also, the image information analysis unit (12) analyzes an area where brightness change in the image frame is equal to or greater than a predetermined value by using at least one of the average brightness level, the brightness histogram information, the color histogram information and the frequency histogram information.

According to another embodiment of the present invention, a brightness control method for performing brightness control on backlights for a display screen based on an input image signal is provided. The brightness control method includes:

an image information analysis step (S02) of analyzing information of at least one item of an average brightness level, brightness histogram information, color histogram information and frequency histogram information that are obtained from an image frame included in the image signal;

a block information obtaining step (S03) of dividing the image frame into blocks and obtaining image information for each of the blocks based on an analysis result of the image information analysis step;

a brightness correction step (S04) of performing brightness correction on backlights corresponding to each of the blocks divided by the block information obtaining step; and

a backlight driving control step (S05) of performing driving control of the backlights for each of the blocks based on correction information obtained by the brightness correction step.

According to the brightness control method, an optimal image that a user can easily watch can be displayed on a display screen, and power consumption can be reduced efficiently.

In the brightness control method, the brightness correction step (S04) includes performing offset correction and/or non-linear correction for a brightness value of the backlights based on the analysis result obtained by the image information analysis step.

The brightness control method may further includes an image correction step (S06) of performing correction for the image signal based on brightness correction information for the backlights that is obtained by the brightness correction step.

The image information analysis step (S06) may include analyzing an area where brightness change in the image frame is equal to or greater than a predetermined value by using at least one of the average brightness level, the brightness histogram information, the color histogram information and the frequency histogram information.

The above reference symbols are merely examples, and the present invention is not limited by the reference symbols. According to embodiments of the present invention, an optimal image or video for a user can be displayed and displaying effective reduction of power consumption can be realized in a display apparatus and the like.

In the present embodiment, contents information other than APL is analyzed, so that the backlight is controlled in conjunction with the analysis result, instead of controlling the backlight by detecting only the APL like the conventional method. In the present embodiment, as examples of the contents information to be analyzed, there are brightness histogram information, color histogram information (including hue, color saturation, or the like), frequency histogram information which are obtained from the image.

Also, in the present embodiment, further optimal backlight control is performed by combining the APL information and the above-mentioned histogram information. Also, in the present embodiment, backlight control that is unaffected by the number of blocks of the backlight is performed by analyzing contents information in detail. In the present embodiment, non-linear correction can be performed in backlight control as well as linear correction according to contents information (including APL and the like).

Further, in the present embodiment, offset control is performed according to contents information (including APL and the like) in backlight control. In addition, in the present embodiment, correction information is sent from backlight information to a signal system in order to reduce backlight interference in backlight control.

In the following embodiments, although a LCD is used as an example of a display unit, the present invention is not limited to the LCD. In the present embodiments, meaning of “image signal” includes both of a signal of moving picture (moving image) and a signal of still image.

### FIRST EMBODIMENT

### Example of Functional Configuration of Brightness Control Apparatus

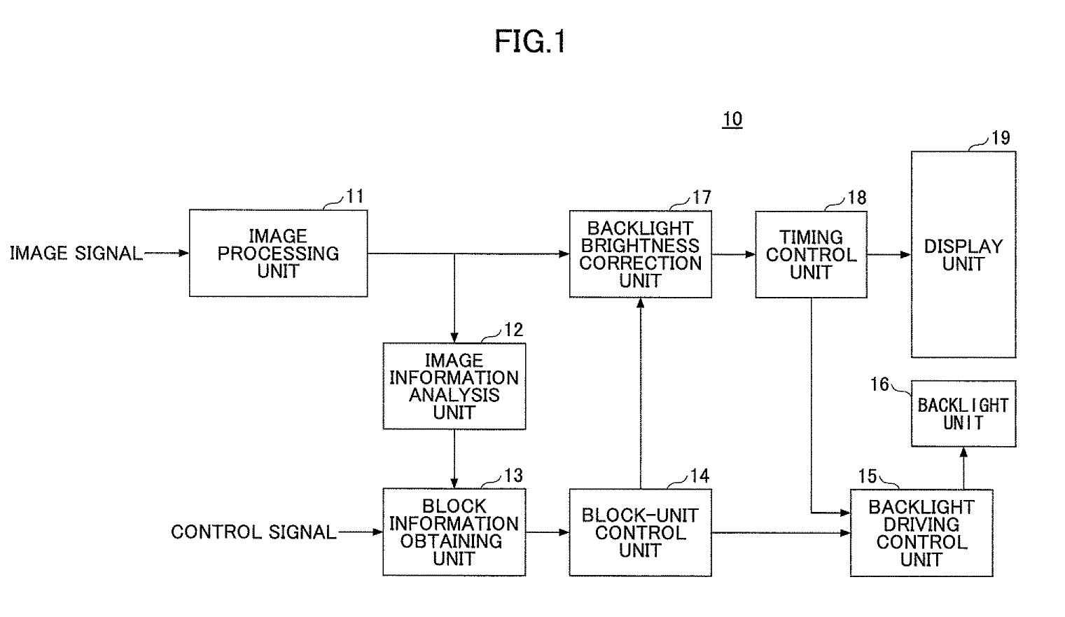

FIG. 1 is a diagram showing an example of a functional configuration of a brightness control apparatus in the first embodiment. The brightness control apparatus 10 shown in FIG. 1 includes an image processing unit 11, an image information analysis unit 12, a block information obtaining unit 13, a block-unit control unit 14, a backlight driving control unit 15, a backlight unit 16, a backlight brightness correction unit 17, a timing control unit 18 and a display unit 19.

The image processing unit 11 decodes an input image signal in a case when the image signal is compression-coded. Also, in a case when the image signal is encrypted by scrambling and the like in a conditional access system, the image processing unit 11 decodes (descrambles) the input image signal using preset key information. That is, the image processing unit 11 properly converts the input image signal such that each unit of the latter stages can process the image signal and that an image can be displayed on the display unit 19. Also, the image processing unit 11 outputs the image signal to the image information analysis unit 12 and to the backlight brightness correction unit 17.

The image information analysis unit 12 performs analysis, on the image signal supplied from the image processing unit 11, in order to detect at least one piece of APL information, brightness histogram information, color histogram information (hue, saturation) and frequency histogram information. Details of processing by the image information analysis unit 12 will be described later. The image information analysis unit 12 outputs an analysis result to the block information obtaining unit 13.

The block information obtaining unit 13 sets a size (the number of pixels, inches and the like) of a block unit based on the analysis result obtained by the image information analysis unit 12 and a preset control signal for the image signal. Accordingly, by setting the size of the block unit based on the image information and the like, the backlight can be controlled for each block, that is, in units of blocks, in association with image information.

The block information obtaining unit 13 performs the above-mentioned processing when the control signal is input. The block information obtaining unit 13 can also automatically perform the above-mentioned processing when the analysis result is input from the image information analysis unit 12 based on preset control information, for example. The block information obtaining unit 13 outputs the obtained block information to the block-unit control unit 14.

The block-unit control unit 14 performs offset control and non-linear correction for each block corresponding to the image signal based on the block information obtained by the block information obtaining unit 13. Also, the block-unit control unit 14 performs modulation processing on the input image signal by PWM (Pulse Width Modulation). Detailed examples of control for each block in the block-unit control unit 14 are described later.

In addition, the block-unit control unit 14 outputs the offset control information and the non-linear correction information of each block included in the image to the backlight driving control unit 15 and the backlight brightness correction unit 17.

The backlight driving control unit 15 performs driving control for backlights corresponding to each block position by using the offset control information and the non-linear correction information for each corresponding block obtained by the block-unit control unit 14.

The backlight driving control unit 15 outputs a timing-controlled driving signal to the backlight unit 16 based on a clock signal from the timing control unit 18 in order to drive backlights in synchronization with the image, displayed on the display unit 19, of the image signal output by the timing control unit 18.

Regarding the backlight unit 16, a backlight (element) includes LED (Light Emitting Diode) elements of three colors (R (red), G (green) and B (blue)) respectively, the three colors being normally provided in an LCD. Therefore, it is desirable to perform adjustment for each LED element in order to adjunct each pixel. However, in this case, remarkable cost and processing time are required. Thus, in the present embodiment, processing is performed for each predetermined block. Accordingly, cost reduction and efficiency can be realized.

The backlight driving control unit 15 outputs a respective driving control signal corresponding to each block to the backlight unit 16. The backlight unit 16 turns on backlights placed at predetermined positions of each block by performing brightness control set for each block based on the corresponding driving control signal, and irradiates the screen of the display unit 19 with light of the backlights.

The backlight brightness correction unit 17 performs brightness correction by the backlight for the image signal obtained by the image processing unit 11 based on the offset control information and the non-linear correction information obtained by the block-unit control unit 14. That is, the backlight brightness correction unit 17 performs trimming by performing reverse-correction on brightness information obtained from signal information beforehand, and the trimmed brightness information is fed back to the image signal side.

The backlights are placed at the backside of the display unit 19, for example, and operate for each block for brightness control. Also, operation of the backlights is brightness operation of low resolution less than the resolution of the image signal. But, according to the present embodiment, block brightness interference due to difference of brightness resolution can be avoided, so that an optimal image that a user can easily watch can be displayed on the display screen.

Also, the backlight brightness correction unit 17 performs correction of the image signal using the offset control information and the non-linear correction information, so that it becomes possible to perform control for brightness, contrast and color and the like as well as impulse control for backlights.

In the present embodiment, it is necessary that the backlight brightness correction unit 17 can properly adjust a correction amount even when information fed back to the image signal side changes according to the configuration of the dimming block, and even when brightness transmittance and the like of the display unit changes. In such a case, for example, the backlight brightness correction unit 17 can automatically adjust information to be fed back by using a result detected by a camera and the like for detecting brightness transmittance that is preset. The backlight brightness correction unit 17 outputs the image signal corrected by the above-mentioned processing to the timing control unit 18.

The timing control unit 18 performs control of time for displaying the image signal obtained by the backlight brightness correction unit 17 in conformity with the horizontal and vertical directions of the screen of the display unit 19, and generates image information displayed on the screen of the display unit 19 and outputs the generated image to the display unit 19.

In addition, in synchronization with the timing for outputting the image signal to the display unit 19, the timing control unit 18 outputs a timing control signal for turning on backlights corresponding to the image signal to the backlight driving control unit 15 in order to turn on the backlights of the backlight unit 16 in synchronization with the image displayed on the screen.

Accordingly, image output by the display unit 19 can be synchronized with backlight output of the backlight unit 16 corresponding to the image.

The display unit 19 displays image information generated by the timing control unit 18 on the screen. As the display unit 19, a LCD panel can be used, for example. But, the present invention is not limited to using the LCD panel as the display unit 19.

According to the above-mentioned configuration, in the present embodiment, backlights of the LCD panel can be dynamically operated in conjunction with image contents. Thus, images of higher contrast can be provided. That is, according to the present embodiment, optimal backlight control can be performed according to image contents.

Therefore, brightness interference to image signals that occurs when performing various dimming operation in the LCD backlight can be improved, so that the dimming operation can be improved into more optimal operation.

Also, in the conventional technique, simple APL detection is mainly performed for backlight control. On the other hand, according to the present embodiment, even though the API, detection result is the same, backlight control can be performed in more detail by using the above-mentioned detection results of various histograms. Therefore, for example, based on the brightness histogram detection, differences between APL 50% having many white components and APL 50% having many black components can be clearly identified. Thus, optimal backlight control can be performed.

Also, in the present embodiment, optical brightness control based on brightness histogram detection can be realized in addition to reference brightness control process by the conventional APL detection. For example, by performing color histogram detection, LED backlight control for RGB can be performed according to optimal white balance control and the like.

That is, in the present embodiment, the backlight brightness control may be performed by using only detection result of the histogram, and also the backlight brightness control may be performed by combining the APL detection result and the histogram detection result.

### <Brightness Control Process Procedure>

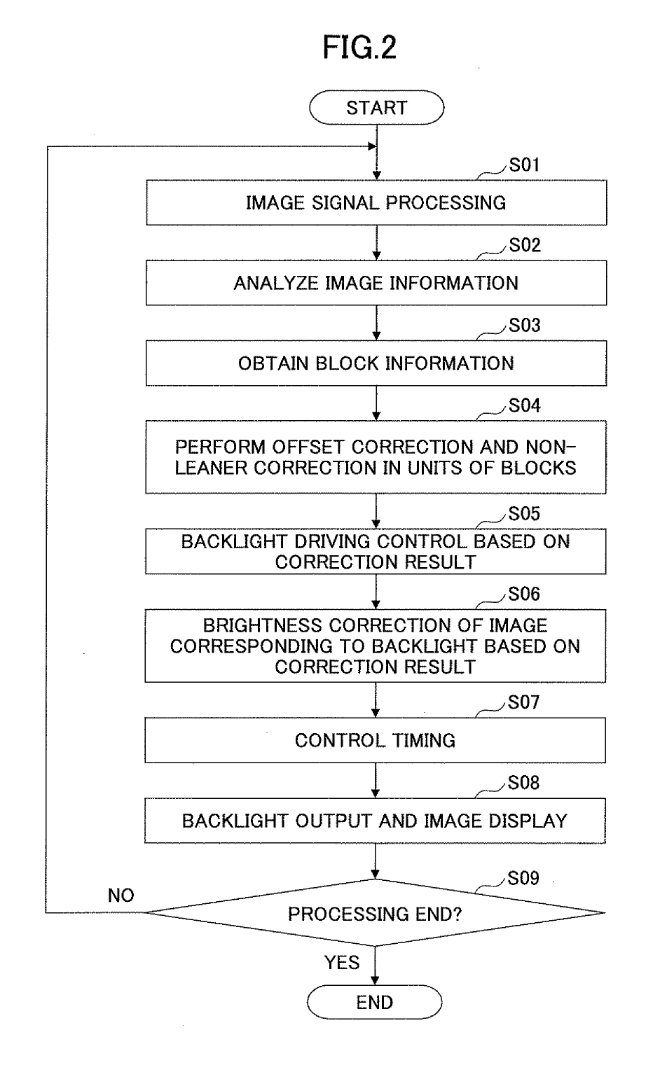

Next, an example of a brightness control process procedure in the brightness control apparatus 10 is described with reference to a flowchart. FIG. 2 is a schematic flowchart showing the example of the brightness control process procedure in the present embodiment.

As shown in FIG. 2, in the brightness control processing of the present embodiment, first, the brightness control apparatus 10 performs image processing on the input image signal such as decoding, averaging, contrast adjustment and the like as mentioned above in step S01. Next, the brightness control apparatus 10 performs image analysis processing on the image signal obtained by the processing of step S01 to detect at least one piece of information of APL detection, brightness histogram detection, color histogram detection, and frequency histogram detection in step S02.

Next, the brightness control apparatus 10 generates blocks for a frame of the image based on the result of the processing of step S02 in synchronization with the image, and obtains block information having identification information identifying each block in step S03. The block information includes, for example, information indicating where each block exists in the frame, and information on the frame divided into the blocks, and the like. Also, the frame is divided in a size that is preset according to contents of the image and the processing performance of the apparatus and the like. The contents of the image include, for example, information of a part where brightness difference is equal to or greater than a predetermined value between adjacent pixels in a frame and/or between pixels of the same position of adjacent frames.

The brightness control apparatus 10 performs offset correction and non-linear correction and the like for each block (in units of blocks) obtained by the processing of step S03 in step S04, and performs backlight driving control based on the correction result (on backlights corresponding to the correction result) in step S05.

Also, the brightness control apparatus 10 performs brightness correction for images corresponding to backlights for the image signal before dividing obtained in the processing of step S01 based on the correction result obtained by the processing of step S04 in step S06. After that, the brightness control apparatus 10 performs timing control for synchronizing the image to be output with backlight output corresponding to the image in step S07, and performs output of the backlights and display of the image in step S08.

Then, the brightness control apparatus 10 determines whether to end the brightness control processing of the present embodiment in step S09. When it is determined not to end (No in step S09), the process returns to step S01 and processes after that are performed. When it is determined to end the process based on an end instruction from a user, for example (Yes in step S09), the brightness control apparatus 10 ends image output processing and backlight output processing performed in the brightness control processing.

Therefore, according to the above-mentioned brightness control procedure, optimal image and/or video for a user can be displayed on a display apparatus. In addition, reduction of power consumption can be realized efficiently. In the above-mentioned processing, processing such as brightness correction of image information is performed by feeding back brightness control information of backlights to the image as shown in the processing of step S06, for example. But, the present invention is not limited to that process. For example, by performing only brightness control for backlights, optimal image and/or video for a user can be displayed on a display apparatus. In addition, reduction of power consumption can be realized efficiently.

Next, a more detailed embodiment is described based on the above-mentioned configuration and the procedure.

### <Brightness Control of Backlight>

The backlight unit 16 applied to the above-mentioned embodiment are provided on a back or side of the display unit 19 such as a LCD panel, for example. Also, the backlight unit 16 comprises light-emitting elements such as LED corresponding to RGB respectively, for example. The backlight unit 16 is divided into block each block including a unit of a plurality of light-emitting elements. Brightness control is performed for each block of the light-emitting elements using a driver IC (Integrating Circuit) corresponding to the light-emitting elements, for example.

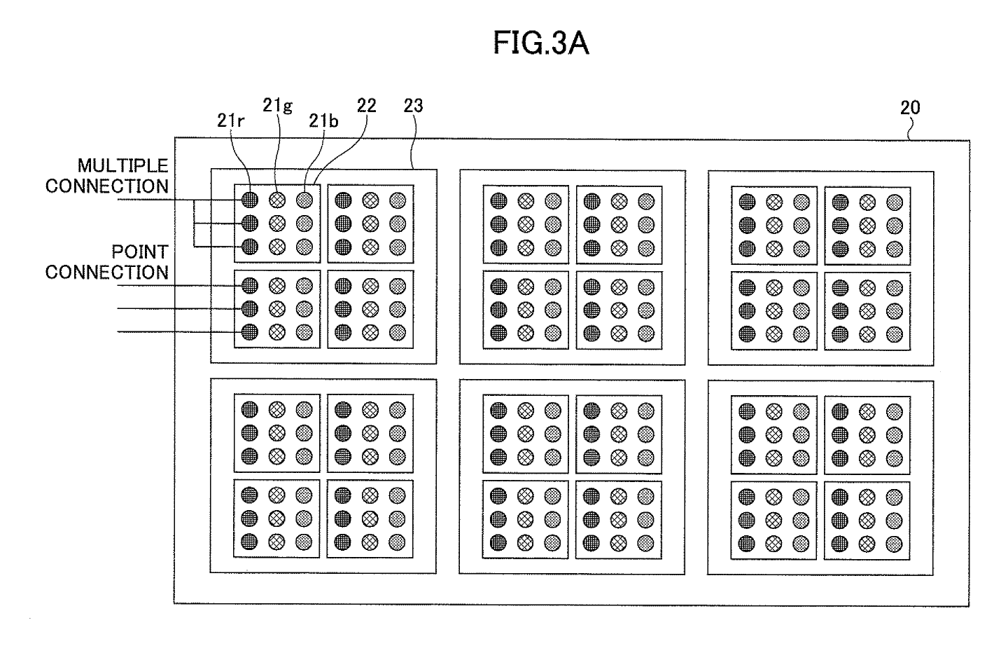

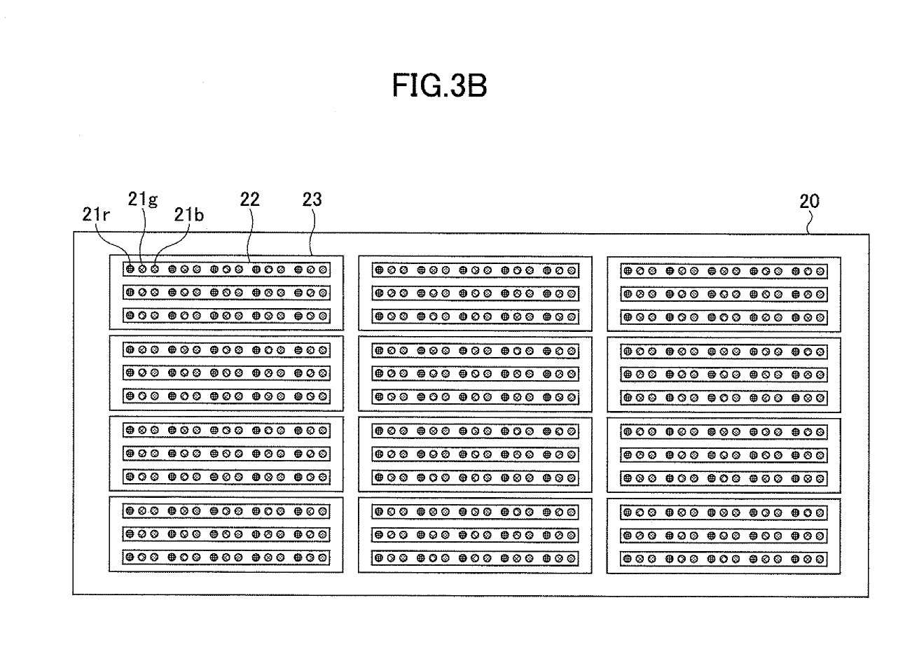

Here, examples of block configurations of the light-emitting elements are described. FIGS. 3A and 3B show examples of block configurations of light-emitting elements that can be applied in the present embodiment. Each of FIGS. 3A and 3B shows LEDs for a LCD backlight unit. As shown in FIGS. 3A and 3B, a predetermined screen display area of the display unit 20 includes elements 21r, 21g and 21b for R, G and B respectively. The elements 21r, 21g and 21b form a cell. Also, a plurality of cells forms an element block 22. Also, these elements are connected to driver ICs by multiple connections or point connection.

In addition, a predetermined number of element blocks are placed at predetermined positions, which form a brightness control block 23 for performing control of brightness correction and the like. In the present embodiment, although examples of the number and the placement of the brightness control blocks are shown in FIGS. 3A and 3B, the present embodiment is not limited to those.

The backlight shown in FIGS. 3A and 3B is a so-called top-type backlight that is placed on the backside of the LCD panel. But, the present invention is not limited to that type. For example, a configuration of a so-called edge type can be used in which the backlight is placed in the lower side of the screen of the display unit 20, or placed in one side (right side, left side) or both sides of the screen.

The brightness control block 23 may be divided into blocks of a size, so that correction for each block of the size can be performed by using at least one of the APL detection, brightness histogram detection, color histogram detection and frequency histogram detection obtained from the input image signal, for example. The present invention is not limited to that. The brightness control block 23 may be divided into blocks of a predetermined size.

### <Backlight Driving Control Unit 15>

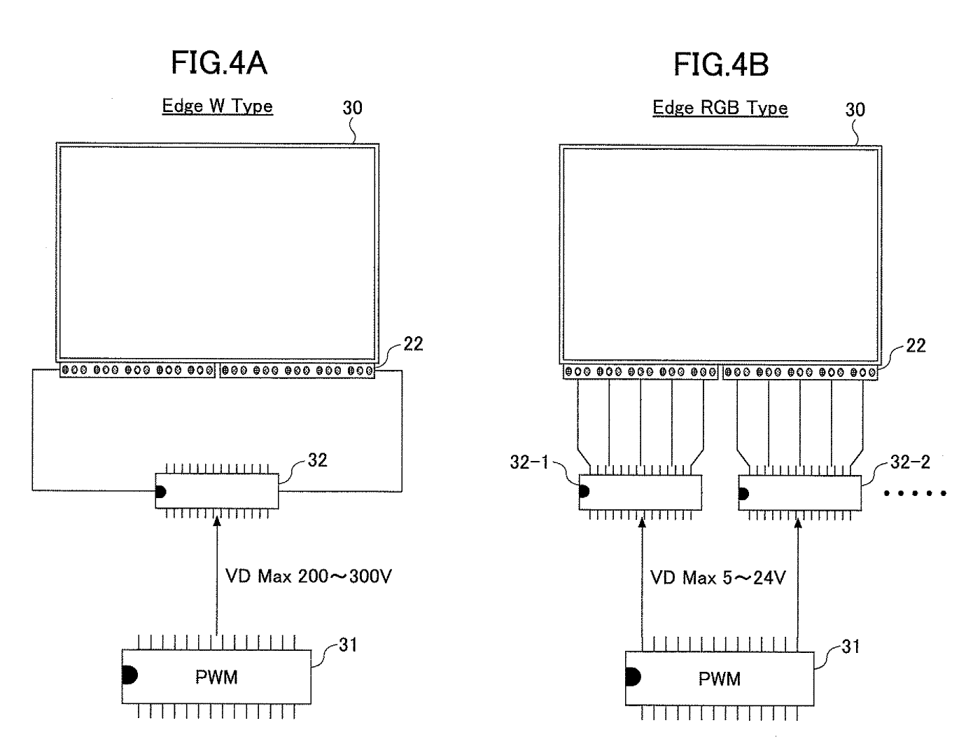

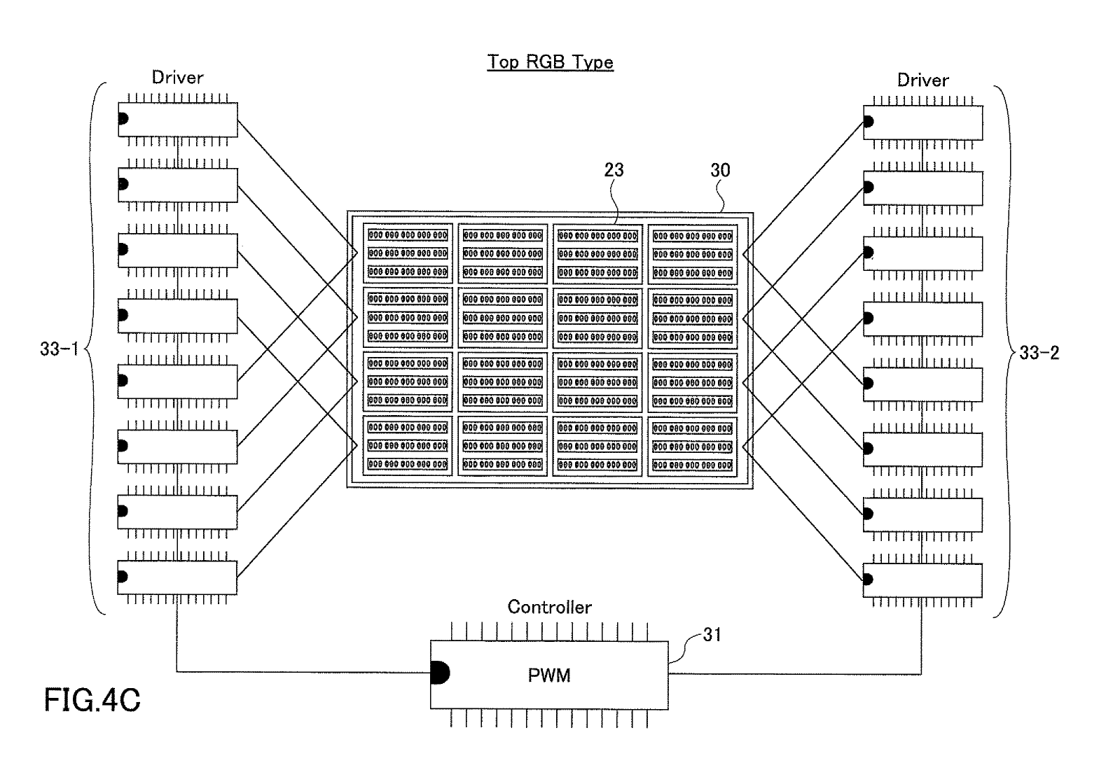

Next, a configuration example of the above-mentioned backlight driving control unit 15 is described with reference to figures. FIGS. 4A-4C are diagrams for explaining outline configurations of the backlight driving control unit 15. FIG. 4A shows a configuration example of an edge W type (edge white type) in which a high-voltage driver is used, and FIG. 4B shows a configuration example of an edge RGB type using a low-voltage driver, and FIG. 4C shows a configuration example of a top RGB type.

As shown in FIGS. 4A-4C, the element block 22 or the brightness control block 23 is placed on a predetermined position of the display unit 30. Driving of backlights is controlled by a panel control IC (PWM) 31. Backlight is output from corresponding LEDs connected to the drive IC 32 or the driver IC group 33 (driver device) by the panel control IC 31.

FIG. 4A shows an example of a case in which the panel control IC 31 can supply a high-voltage of 200-300V at the maximum. For a case of low-voltage, as shown in FIG. 4B, by providing a plurality of driver ICs 32-1, 32-2, . . . a low-voltage of 5-24V at the maximum can be supplied, for example.

As shown in FIG. 4A-4C, one driver IC 32 or a plurality of driver ICs 33 control output of a plurality of elements.

### <Internal Configuration of the Backlight Driving Control Unit 15>

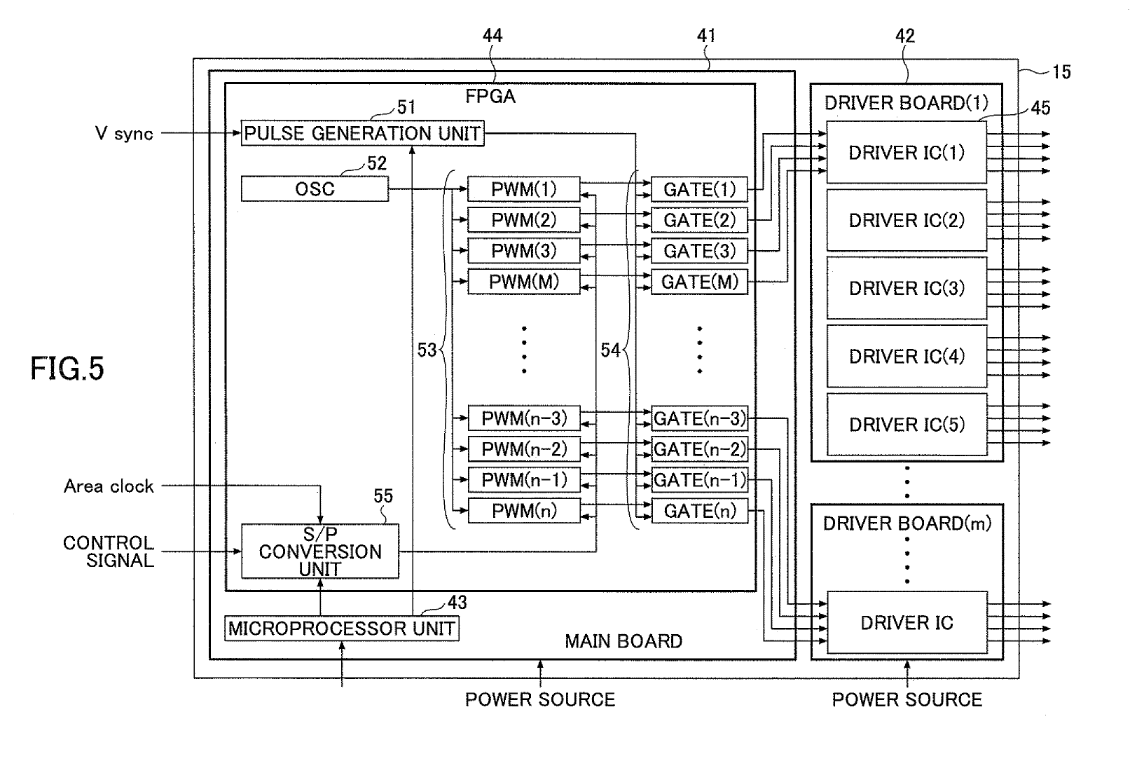

Next, an internal configuration example of the backlight driving control unit 15 is described in detail. FIG. 5 is a diagram showing an internal configuration example of the backlight driving control unit 15.

The backlight driving control unit shown in FIG. 5 includes a main board 41 and a driver board 42. The main board 41 includes a microprocessor unit 43 and a FPGA (Field Programmable Gate Array) 44. The driver board 42 includes a plurality of driver ICs 45. Also, the FPGA 44 includes a pulse generation unit 51, an OSC (Oscillator) 52, a PWM array 53, a gate array 54, and a S/P (serial parallel) conversion unit 55. Further, power is supplied from a power supply to the main board 41 and the driver board 42 shown in FIG. 5.

Based on control information obtained from the microprocessor unit 43, the main board 41 outputs a control signal for driving backlights of each block provided in the backlight unit 16 to one or more driver ICs corresponding to the control information in one or more driver ICs provided on one or more driver boards 42 by using the gate array 54 formed in the FPGA 44.

More particularly, in the main board 41, the pulse generation unit 51 in the FPGA 44 generates a pulse signal for performing brightness control of backlights in synchronization with the timing of the image signal based on a synchronization signal (Vsync) obtained from the timing control unit. Then, the pulse generation unit 51 outputs the generated pulse signal to each gate array 54.

The OSC 52 generates a reference signal that becomes a reference of a PWM signal generated by each PWM circuit of the PWM array 53, and outputs the reference signal to each PWM circuit of the PWM array 53.

Also, in the main board 41, the S/P conversion unit 55 provided in the FPGA 44 converts the control signal in a serial form obtained from the block-unit control unit 14 into a signal of a parallel form based on an area clock of each block, and outputs the control signal to PWM circuit(s) corresponding to the area clock among the PWM circuits 1-n provided in the PWM array 53.

In the PWM array 53, each PWM circuit performs pulse width modulation based on the reference signal obtained by the OSC 52 and the control signal obtained by the S/P conversion unit 55, so as to generate a control signal for controlling ON/OFF of light emission of the light-emitting element such as the LED, for example. Then, the PWM circuit outputs the generated signal to a gate circuit corresponding to each PWM circuit provided in the gate array 54.

In the gate array 54, based on the pulse signal obtained from the pulse generation unit 51 and the control signal obtained from the PWM array 53, a control signal is output from gate circuit(s) to one or more driver ICs corresponding to the gate circuit(s) provided on the gate array 54 among one or more driver ICs provided on the driver boards 42.

The microprocessor unit 43 outputs a control signal to the pulse generation unit 51 and the S/P conversion unit 55 based on externally set information or pre-recorded setting information and the like. Accordingly, the backlight driving control unit 15 can cause each backlight provided in the backlight unit 16 to perform proper driving operation.

In the driver boards 42, one or more driver ICs (driver ICs 1-5 in the driver board (1) in the example of FIG. 5, for example) in each driver board (driver board 1-m in the example of FIG. 5, for example) output a driving control signal for driving each backlight of the backlight unit 16 based on the signal obtained from the corresponding gate circuit. Accordingly, the driving control signal generated by each driver IC is output to the backlight unit 16 so that control of each backlight is performed.

In each of the PWM array 53 and the gate array 54, a plurality of elements are provided so that it can support the number of brightness control blocks 23 that is variably set for each image. That is, in each of the PWM array 53 and the gate array 54, a number of elements for supporting the maximum number of blocks that can be divided in the display unit can be provided. In the present embodiment, as a unit for dividing, each pixel (1×1 pixel), a square block such as 2×2 pixels, 4×4 pixels, and 16×16 pixels can be considered, for example. But, the present invention is not limited to these. Also, each PWM circuit and each gate circuit may control backlight elements corresponding to a plurality of blocks that are predetermined.

The backlight driving control unit 15 performs the above-mentioned processing, so that corresponding backlight elements such as LEDs can be turned on or off at proper timing based on the driving control signal from the driver ICs 45.

### SECOND EMBODIMENT

Next, a second embodiment of the present invention is described. In the second embodiment, brightness control processing for backlights is performed based on the image signal obtained by the image processing unit 11 shown in FIG. 1 without performing processing for the image. In the description of the following embodiment, configuration units having the same function of the above-mentioned brightness control apparatus are assigned the same reference symbols, and detailed description is not provided for the units.

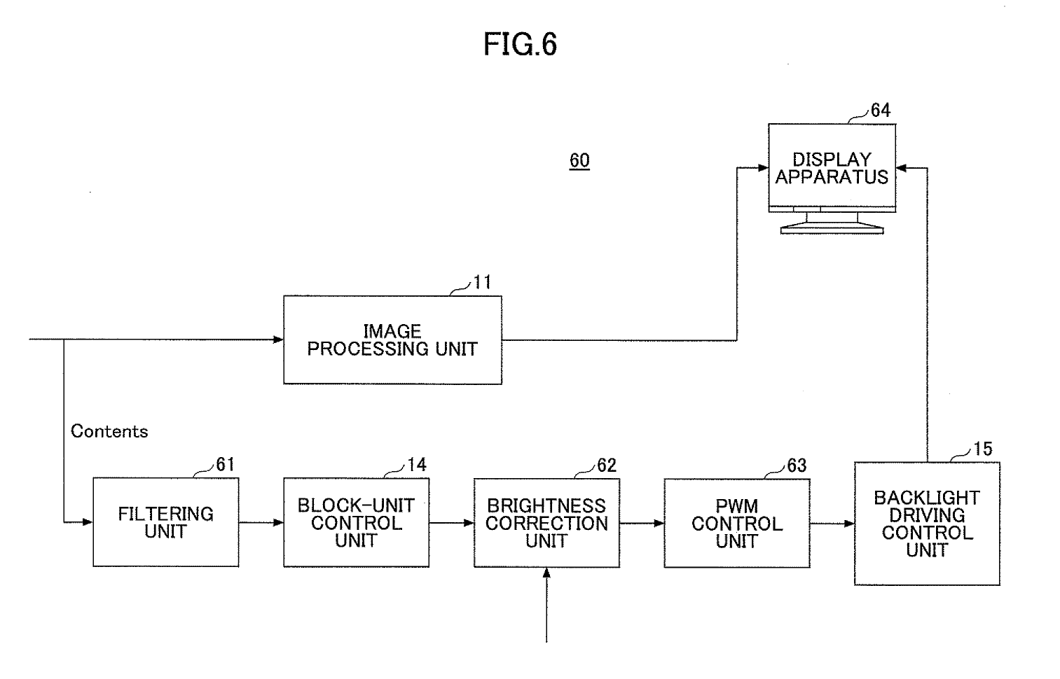

FIG. 6 shows an example of a functional configuration of a brightness control apparatus in the second embodiment. The brightness control apparatus 60 shown in FIG. 6 includes an image processing unit 11, a filtering unit 61, a block-unit control unit 14, a brightness correction unit 62, a PWM control unit 63, and a display apparatus 64. The display apparatus 64 includes at least the above-mentioned backlight unit 16 and the display unit 19.

In the brightness control apparatus 60 of the second embodiment, an input image signal is output to the image processing unit 11 and to the filtering unit 61. The image processing unit 11 performs the above-mentioned image processing on the image signal and outputs the image signal to the display apparatus 64 at a proper timing.

The filtering unit 61 performs filtering processing on the signal using a low-pass filter according to a grade of the input image signal in order to perform smoothing processing for the signal before performing processing in later stages. In addition, the filtering unit 61 decodes an input image signal in a case when the image signal is compression-coded. Also, in a case when the image signal is encrypted by scrambling and the like in a conditional access system, the filtering unit 61 decodes (descrambles) the input image signal using preset key information and the like.

The filtering unit 61 outputs the filtered image signal to the block-unit control unit 14. The block-unit control unit 14 performs brightness control processing which includes at least one of APL detection, brightness histogram detection, color histogram detection and frequency histogram detection for each block. In the present embodiment, it is desirable to combine APL detection result with at least one of the histogram detection results in the brightness control processing. The block-unit control unit 14 outputs a control signal for each block to the brightness correction unit 62.

The brightness correction unit 62 corrects brightness information of backlights for each block (in units of blocks) using externally set information or pre-recorded setting information based on the brightness control processing result for each block, and outputs the correction signal to the PWM control unit 63.

The PWM control unit 63 generates a backlight driving control signal based on the corrected brightness information, and outputs the generated backlight driving control signal to the backlight driving control unit 15. Therefore, the backlight driving control unit 15 can control the backlights of the whole screen provided in the display apparatus 64 for each block by the above-mentioned processing.

As mentioned above, in the second embodiment, brightness correction is performed only for backlights. By adopting such configuration, as mentioned above, an optimal image that a user can easily watch can be displayed on the display screen, and power consumption can be reduced efficiently. In addition, the apparatus can be realized by a configuration that is simpler than that of the first embodiment.

### THIRD EMBODIMENT

Next, a third embodiment of the present embodiment is described. In the third embodiment, for processing of the image of the input image signal, white balance correction, contrast correction and color correction and the like are performed. In the description of the following embodiment, configuration units having the same function of the above-mentioned brightness control apparatuses 10 and 60 are assigned the same reference symbols, and detailed description is not provided for the units.

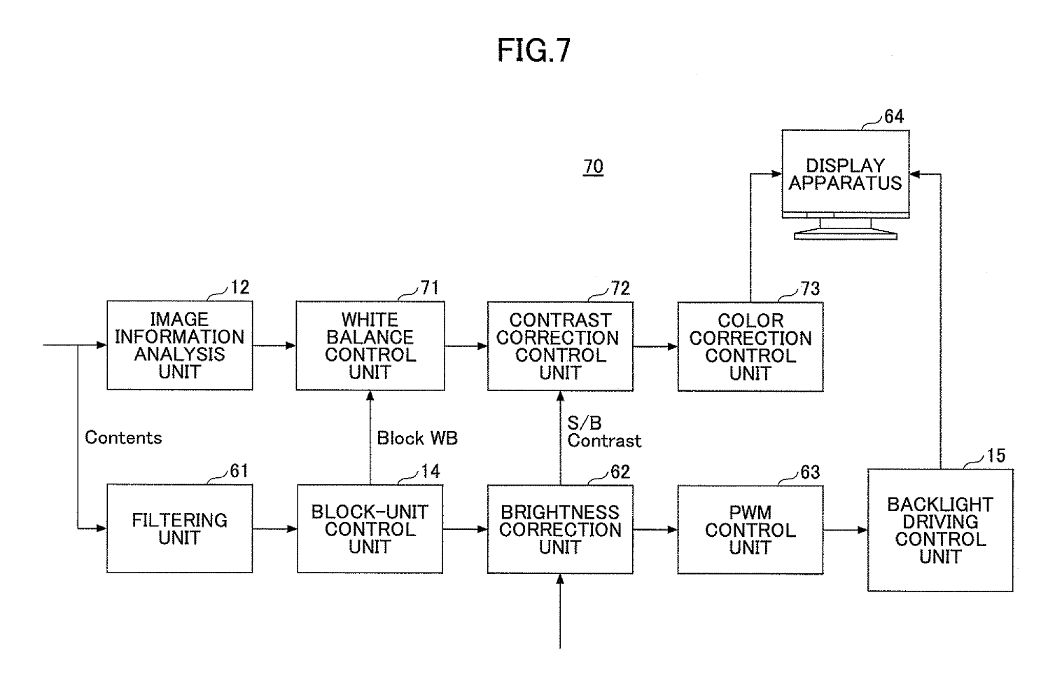

FIG. 7 shows an example of a functional configuration of a brightness control apparatus in the third embodiment. The brightness control apparatus 70 shown in FIG. 7 includes an image information analysis unit 12, a white balance control unit 71, a contrast correction control unit 72, a color correction unit 73, a filtering unit 61, a block-unit control unit 14, a brightness correction unit 62, a PWM control unit 63, a backlight driving control unit 15 and a display apparatus 64. At least one of processes of the white balance control unit 71, the contrast correction control unit 72 and the color correction unit 73 corresponds to a process of an image correction unit.

In the brightness control apparatus 70 of the third embodiment, an input image signal is output to the image information analysis unit 12 and to the filtering unit 61. The image information analysis unit 12 performs APL detection, brightness histogram detection, color histogram detection and frequency histogram detection for the image information as mentioned above, and outputs an obtained result to the white balance control unit 71.

In addition, the image information analysis unit 12 can decode an input image signal in a case when the image signal is compression-coded. Also, in a case when the image signal is encrypted by scrambling and the like in a conditional access system, the image information analysis unit 12 can decode (descramble) the input image signal using preset key information and the like.

The white balance control unit 71 performs white balance control on the image signal based on the input result. The white balance control unit 71 corrects white balance for each block corresponding to block information obtained from the block-unit control unit 14.

The contrast correction unit 72 performs contrast correction for an image signal, on which white balance correction has been performed, obtained from the white balance correction control unit 82 based on contrast information obtained from the brightness correction unit 62.

Further, the color correction unit 73 performs color correction on the image signal obtained from the contrast correction control unit 72 based on predetermined conditions such as characteristics and performance of the display apparatus 64 and the like, so as to display the image on the display apparatus 64. As to backlight correction, similar processing as the second embodiment is performed. Accordingly, in the third embodiment, an optimal image that a user can easily watch can be displayed on the display screen, and power consumption can be reduced efficiently.

### <Multi-Dimming Processing>

In the above-mentioned first to third embodiments, as mentioned above, at least one piece of information of APL detection, brightness histogram detection and color histogram detection (hue, saturation) is used for detecting image information and control backlights for each block. Thus, it becomes possible to realize backlight brightness control (dimming) that is unaffected by the number of blocks of backlights. Also, by applying the present embodiment, multi-dimming processing can be provided such as automatic backlight scanning system (including block information), automatic timing filtering (no block information) and multiple non-linear correction backlight control.

In the present embodiment, by analyzing contents information other than APL, the above-mentioned various pieces of histogram information are detected for controlling backlights, so that optimal backlight control is performed. Optimal backlight control may be performed by adding APL information to the various pieces of histogram information. In addition, backlight control that is unaffected by the number of blocks is performed by analyzing contents information in detail. Further, not only linear correction according to contents information (APL and the like) but also non-linear correction is performed for controlling backlight control characteristics.

In addition, in the present embodiment, offset control can be performed on the control characteristics of backlights according to contents information (APL and the like). Further, correction information can be sent from backlight information to signal system for reducing backlight block interference due to backlight control.

### <Brightness Correction>

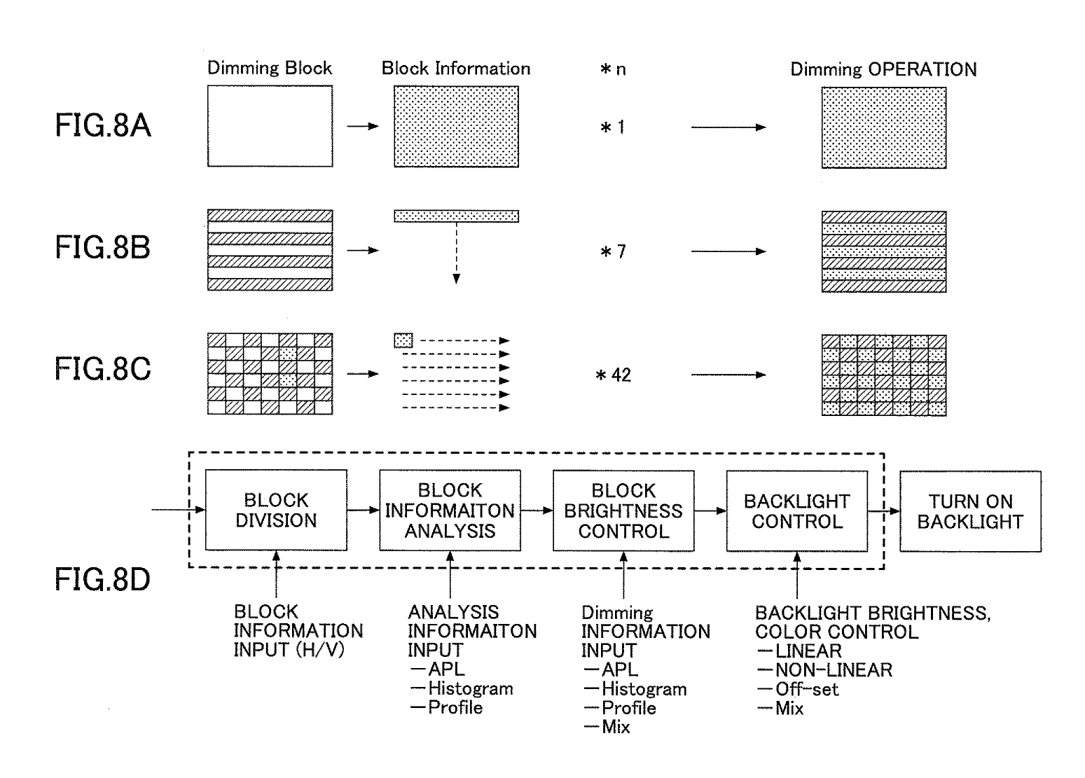

In the following, concrete examples of brightness correction in the above-mentioned embodiments are described with reference to figures. FIGS. 8A-8C show correction patterns in brightness correction. FIG. 8D shows a procedure for block dimming processing.

In the present embodiment, as shown in FIGS. 8A-8C, dimming operation such as turning on/turning off of LED backlights is performed based on respective block information. FIG. 8A shows an example for performing block brightness control in which the number (*n) of block division is 1. FIG. 8B shows an example for performing block brightness control in which the number of block division is 7. FIG. 8C shows an example for performing block brightness control in which the number of block division is 42. But, the present invention is not limited to these division numbers.

In the present embodiment, as shown in FIG. 8D, for the input image information, an input image frame is divided into a number of blocks based on input block information (for example, the above-mentioned division number of 1, 7, 42 or the like). Then, for each divided block, block information is analyzed based on analysis information that is input beforehand such as APL, histograms, and various profiles such as waveform.

Next, in the present embodiment, APL and block brightness control are performed on the analyzed block information based on dimming information that is input beforehand (for example, APL, histograms, profiles or mixture of these). Also, in the present embodiment, control of backlight correction is performed based on the brightness control information for each block that is obtained, and based on input backlight brightness and color control information, so that corrected backlight elements are turned on. The control information may include control information of linear correction, non-linear correction, offset correction or mixture of these, for example.

In the above-mentioned processing, by generating and displaying a specific setting screen on a display unit, various pieces of input information can be set by a user using an input means, so that detailed setting can be made easily. Examples of the setting screens are described with reference to figures.

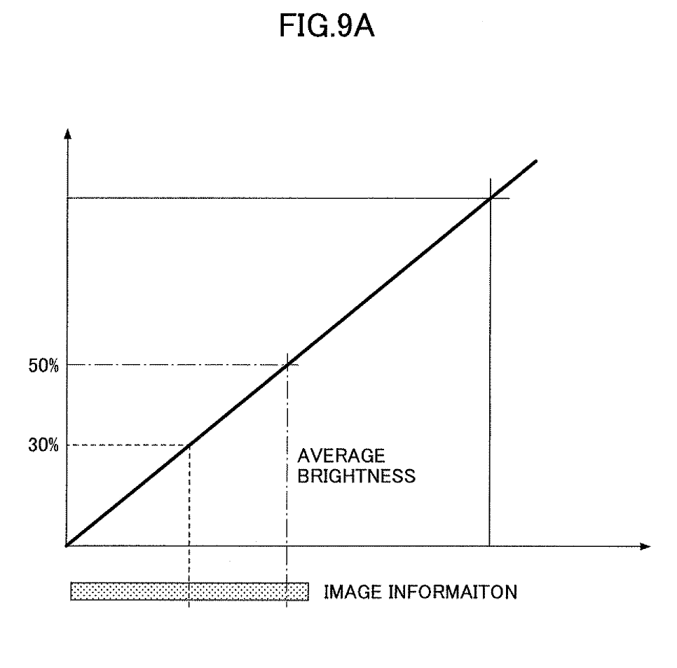

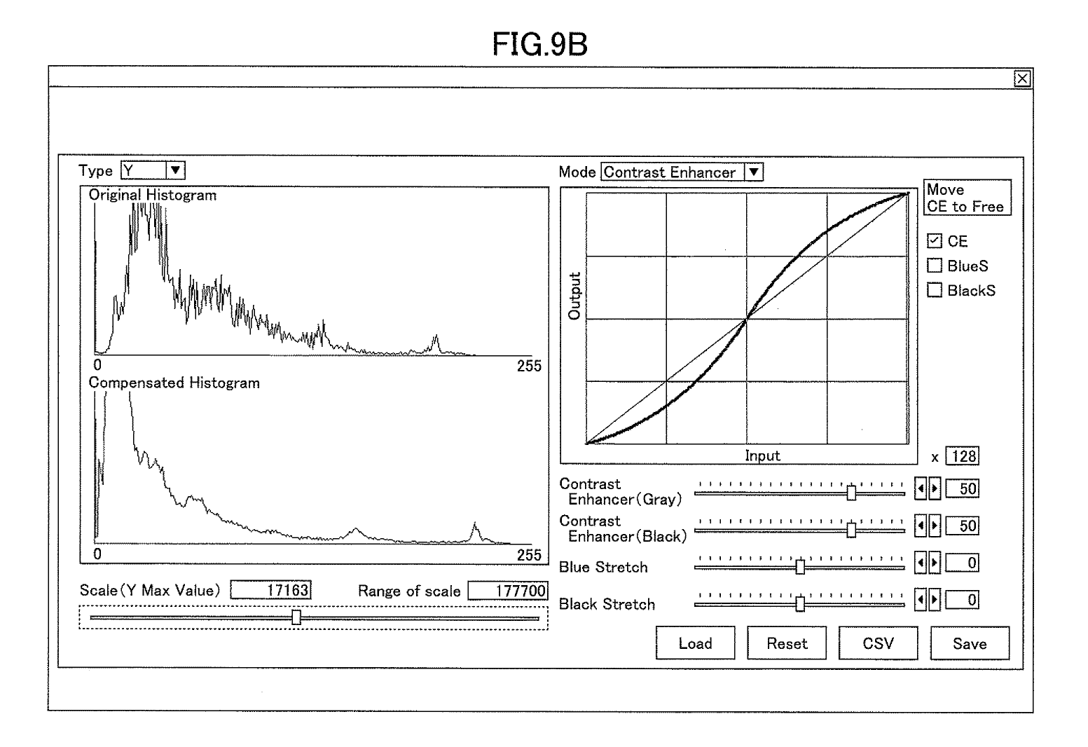

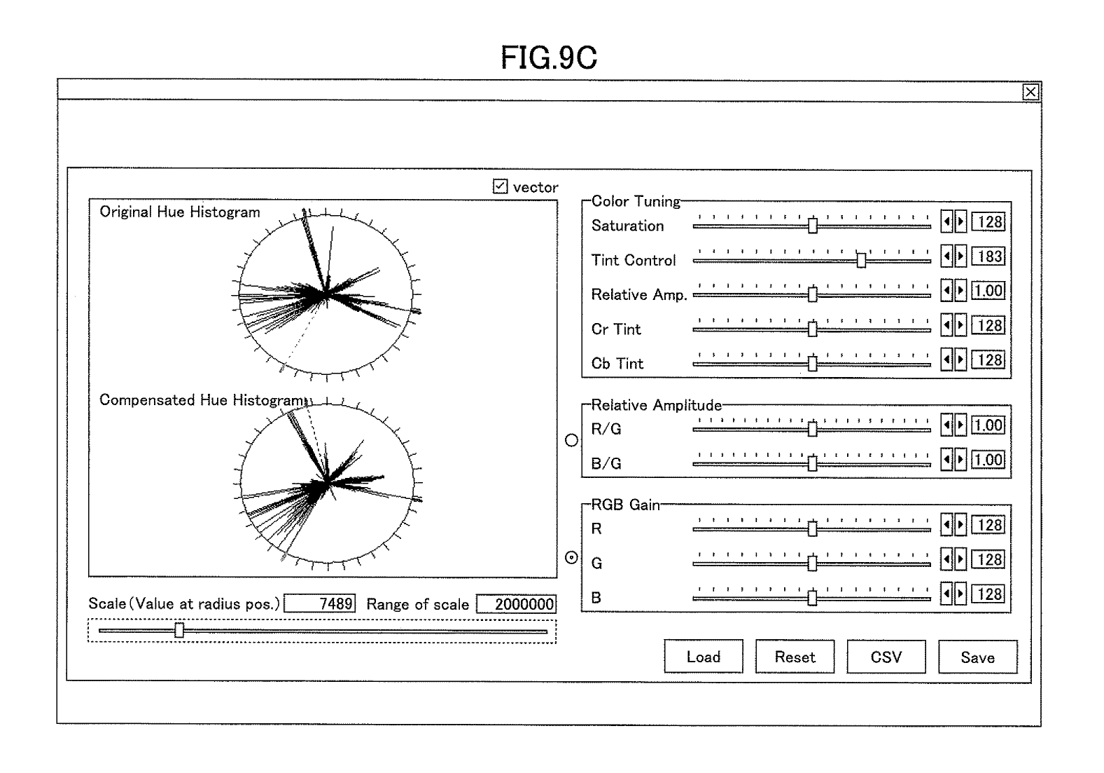

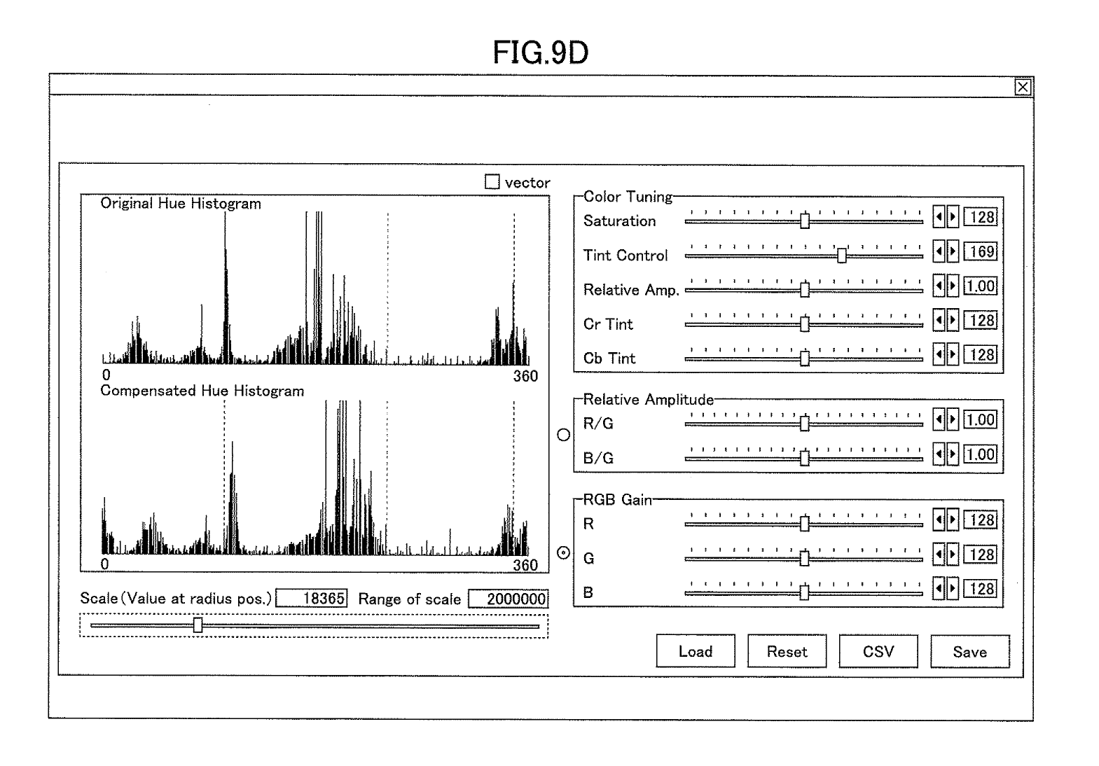

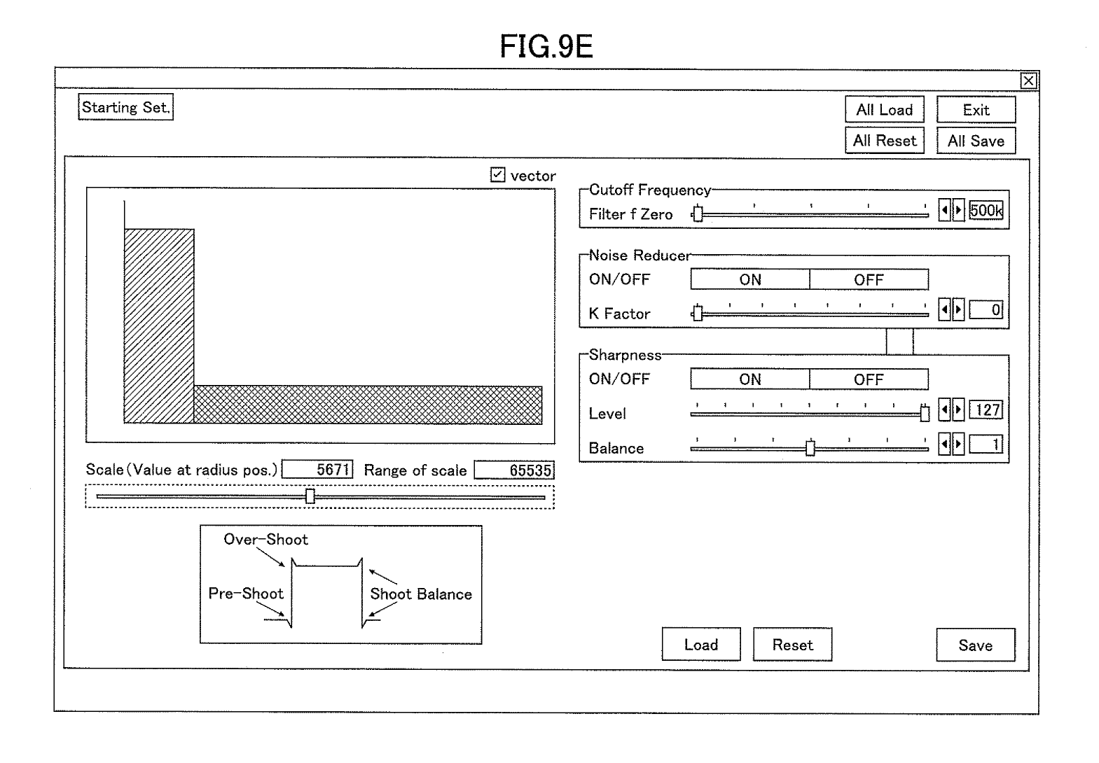

FIGS. 9A-9E are diagrams showing examples of setting screens for setting various conditions for brightness control. These screens also have a function of a dimming contents analyzer.

FIG. 9A shows an example of a setting screen of APL. FIG. 9B shows an example of a setting screen of a brightness histogram. FIG. 9C shows an example of a setting screen of a hue histogram. FIG. 9D shows an example of a setting screen of a color saturation histogram. FIG. 9E shows an example of a setting screen of a frequency histogram.

In the APL setting screen example shown in FIG. 9A, APL is detected from an image signal for performing brightness control of backlights, and linear correction is performed based on the detected result. In the example of FIG. 9A, correction is not limited to the linear correction. Non-linear correction and offset correction can be also performed. Concrete examples of these are described later.

In the setting screen of brightness histogram shown in FIG. 9B, setting information (for example, table) for performing partial correction of backlight brightness is adjusted. The setting information is for converting RGB of 0-255 into RGB of 0-255 in which white balance has been corrected. For example, in the example shown in FIG. 9B, a histogram (original histogram) of values of brightness or RGB of an image signal included in the original image is displayed as a graph. Also, a histogram (compensated histogram) of values of brightness or RGB in which correction has been performed by using the setting information such as a table is displayed as a graph. In the display of the histograms, when resolutions between signals of before-correction and after-correction are different, normalization is performed such that the total number of pixels of the image signal after correction becomes the same as the total number of pixels of the image signal before correction. Accordingly, comparison between them can be easily performed. According to the brightness histograms, it can be easily ascertained how much bright color or white color is included for each image, for example.

Also, in the setting screen of the brightness histogram shown in FIG. 9B, a type of a correction table can be selected as a mode, and relationship between input and output is displayed when the mode is applied. The form of the correction table can be corrected on the screen. Therefore, for example, only a dark part may be corrected, only a bright part may be corrected, and also, correction values may be changed between the dark part and the bright part. Each piece of setting information on these brightness histograms can be adjusted using a slider and the like on the screen.

In addition, the two setting screens of a color histogram shown in FIGS. 9C and 9D show a hue histogram and a color saturation histogram respectively. In each setting screen, a basic setting for color is performed such as color tuning and RGB gain and the like.

For example, in the setting screen example of the hue histogram shown in FIG. 9C, an original hue histogram of the image signal included in an original image is displayed as a graph, and a compensated hue histogram of the image after correction is displayed as a graph.

The hue in the present embodiment is an angle in the vector scope. Also, the two histograms before correction and after correction are displayed by being redrawn every 0.5-1 second, for example. Although the histogram is shown as a circle graph in FIG. 9C, the present invention is not limited to that. For example, a bar graph can be displayed.

For example, in the color saturation histograms shown in FIG. 9D, color saturation histograms before correction and after correction are displayed as bar graphs. The graph to be displayed can be switched between the circle graph and the bar graph according to presence or absence of a check-mark in the check box (vector).

In the display of the histograms shown in FIG. 9C and 9D, when resolutions between signals of before-correction and after-correction are different, normalization is performed such that the total number of pixels of the image signal after correction becomes the same as the total number of pixels of the image signal before correction.

Each piece of setting information such as color tuning and RGB gain on these color histograms can be adjusted using a slider and the like on the screen.

Also, in the setting screen for the frequency histogram shown in FIG. 9E, adjustment of noise reduction and sharpness is performed for the histogram of frequency component. That is, in the setting screen displayed on FIG. 9E, a value (scale) corresponding to an upper end of the vertical axis of the graph of the histogram can be changed using a slider or an edit box. Accordingly, the height of the histogram to be displayed can be changed. Also, in the setting screen shown in FIG. 9E, the maximum value of the changeable range of the slider for scale can be edited, each of noise reduction function and sharpness correction function can be changed to ON or OFF, and also, a degree of noise reduction and a degree of sharpness correction can be set, and a corresponding frequency histogram can be displayed.

In addition, in the setting screen shown in FIG. 9E, for example, cutoff frequency for calculating the frequency histogram in the FPGA can be set.

As mentioned above, according to the present embodiment, various setting screens are provided, so that the user can set various setting information, and that histogram information and profile information in a proper range can be obtained. Thus, brightness control of backlights can be performed optimally based on these pieces of information.

In the following, an example of brightness control using the ALP setting screen shown in FIG. 9A is described in more detail.

### <Dynamic Backlight Brightness Control>

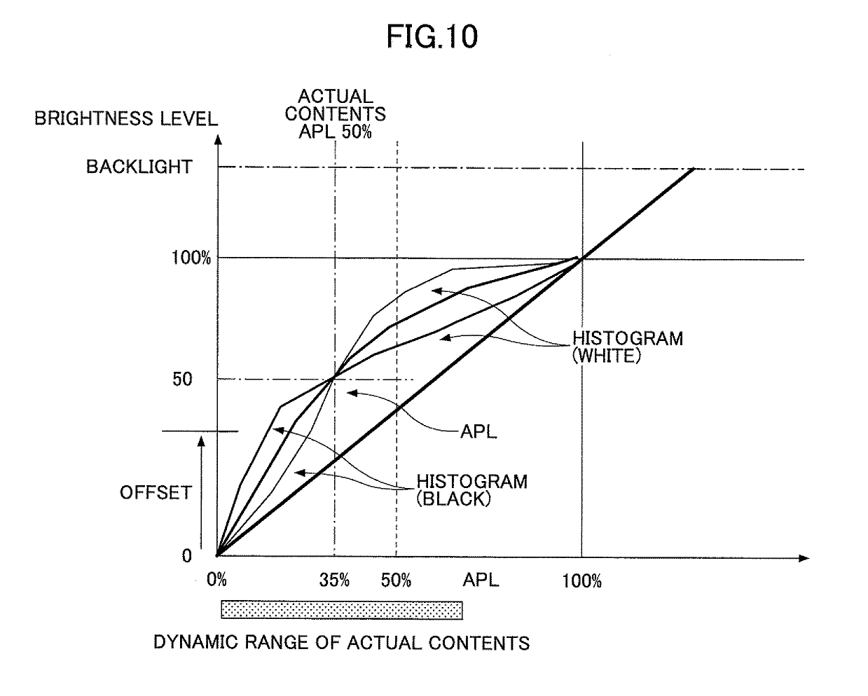

In the present embodiment, a concrete example of optimal dynamic backlight control is described with reference to FIG. 10. FIG. 10 is a diagram for explaining a concrete example of optimal dynamic backlight control according to the present embodiment. FIG. 10 shows an example of optimal brightness control for APL in which the horizontal axis indicates APL detection value (%) and the vertical axis indicates brightness level of backlight.

In the present embodiment, centering is performed based on actual dynamic range using APL detection, for example, according to the result of APL and backlight shown in FIG. 10, so that non-linear correction is performed using various histogram detections for white and black.

More particularly, for example, for controlling brightness of backlights of the LCD panel, it is generally known that brightness control is performed linearly based on APL information of the image signal for reducing power consumption. If such brightness control depending on APL is simply (linearly) performed, although power consumption can be reduced, a side effect that contrast decreases may occur. The reason is that APL range of actually used image signal is concentrated on a range of 20-50% (30-40% in average).

Thus, for setting an APL curve for backlight control by using APL of actually used image signal as a reference, it is optimal to set a value near APL 35% to be a 50% value of backlight brightness. Therefore, in the present embodiment, a non-linear control curve is set in which the point near APL 35% is set to be the 50% value of backlight brightness. Accordingly, consumed power can be reduced without lowering contrast.

Also, in the present embodiment, APL and brightness histogram information of the image signal are detected, and control is performed in a two stage scheme. Thus, brightness control for backlight can be performed ideally and optimally.

That is, in the present embodiment, in the backlight brightness control, the reference value (50%) is determined by APL detection of the image signal (actual contents), first. Then, a simple non-linear curve centered on the reference value (center of actual dynamic range) is set. Next, when many dark brightness components are detected from the brightness histogram data, a brightness offset is applied to the curve, and control is performed on the curve of the black brightness part. Or, when there are many bright components, control is performed for the curve of the white part, for example. Accordingly, optimal image that can be easily seen can be obtained, and power consumption can be reduced efficiently.

According to the present embodiment, by performing optimal backlight control using APL and brightness histogram information, an optimal high contrast image can be obtained while realizing efficient and low power consumption.

### <Non-Linear Control and Offset Control for Backlight Brightness>

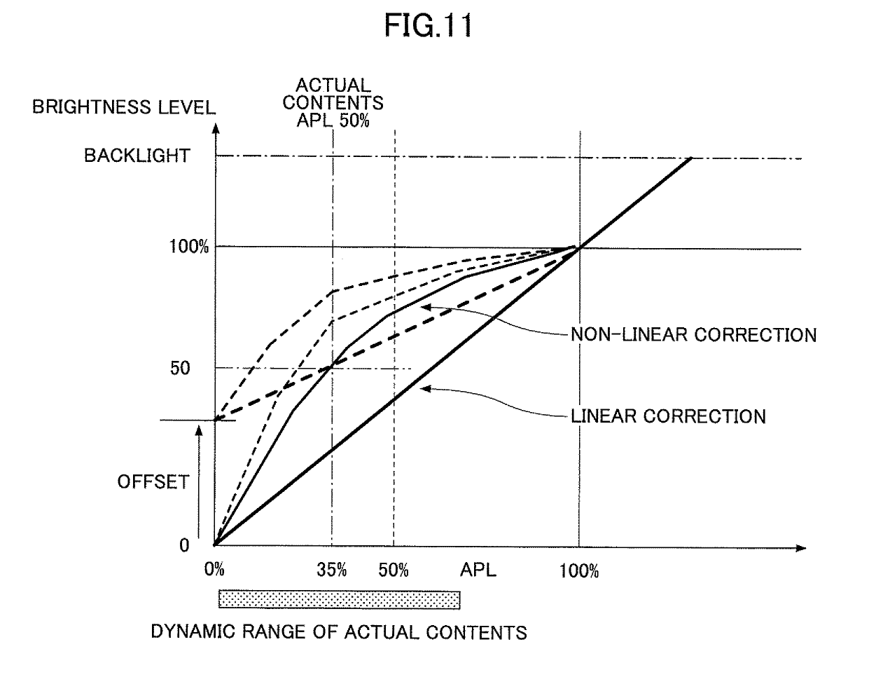

Next, non-linear and offset control for backlight brightness is described in more detail with reference to FIG. 11. FIG. 11 is a diagram for explaining non-linear and offset control for backlight brightness in the present embodiment. In FIG. 11, similar to FIG. 10, the horizontal axis indicates APL detection value (%) and the vertical axis indicates a brightness level (%) of backlight.

Also in the non-linear and offset control, as shown in FIG. 11, a non-linear control curve is set in which the point near APL 35% corresponds to the value of backlight brightness 50%. Thus, contrast is not lowered while reducing power consumption.

In addition, by increasing the brightness level of the backlight from 0% to 30-40%, for example, by using an offset, brightness control can be performed for backlights without darkening the image.

According to the present embodiment, low power consumption can be realized without decreasing the contrast. Also, by providing the offset control function in which minimum brightness of backlight can be set, more precise images can be provided.

Accordingly, for example, backlights of the display unit such as a LCD panel can be caused to dynamically operate in conjunction with image contents. Also, contents analysis can be performed for performing optimal backlight control for obtaining images of higher contrast.

The contents analysis is described in more detail as follows. Conventional contents analysis for backlight control is mainly based on simple APL detection. However, according to the simple APL detection, backlight control cannot be performed optimally for image contents. Thus, there is a drawback in which control operations become the same between APL 50% information in which there are many black components and APL 50% information in which there are many white components. Therefore, whiteout and blackout may easily occur. In the present embodiment, even though values of APL are the same, difference between APL 50% having many white components and APL 50% having many black components can be clearly distinguished by the brightness histogram detection, so that optimal backlight control can be performed.

As described in the present embodiments, by performing non-linear LED backlight control, high contrast can be easily realized while largely decreasing power consumption for dimming (control of brightness of LED).

Therefore, optimal backlight control suitable for image contents can be performed. And, processing can be performed such as reference brightness control by APL detection, optimal brightness control by brightness histogram detection, and optimal while balance control (for RGB LED backlight, for example) by color histogram detection, and the like.

### <Dimming Block Interference Prevention>

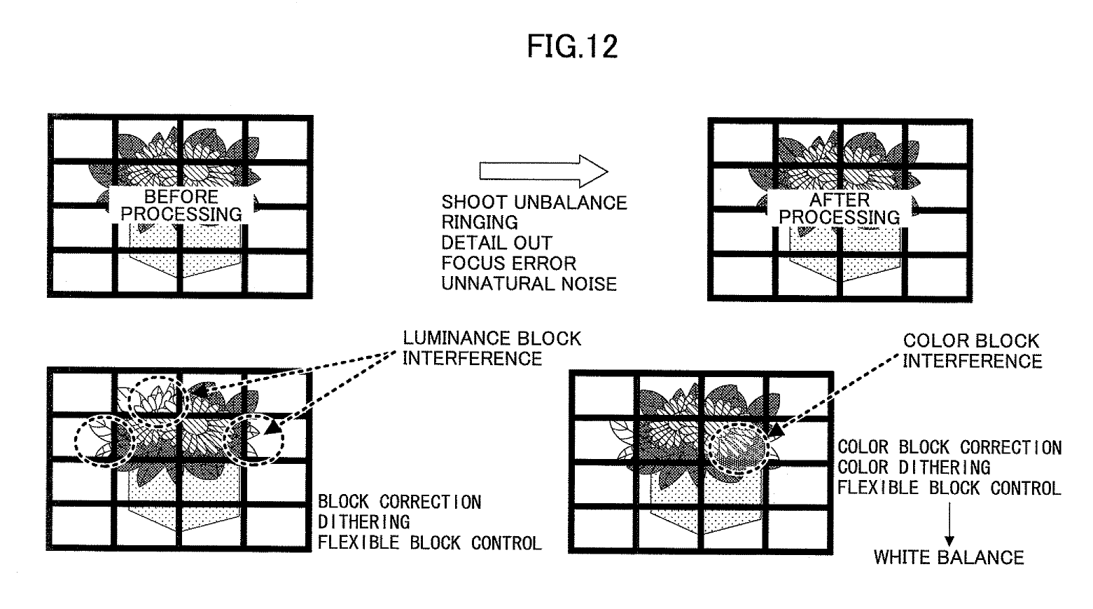

Next, a concrete example of dimming block interference prevention obtained by applying the present embodiment is described with reference to FIG. 12. FIG. 12 is a diagram for explaining a concrete example of dimming block interference prevention of the present embodiment.

In the example shown in FIG. 12, a schematic image of a flowerpot and a flower are displayed on a screen. For example, conventional backlight elements are placed in the backside of the LCD panel, and the brightness operation of the backlight elements is performed in units of blocks for dimming. Since the operation of the backlight is brightness operation of low resolution less than the resolution of the image signal, there occurs a difference between brightness resolutions of the backlight and the image signal. This causes the dimming block brightness interference. Especially, this phenomenon often occurs at a part where brightness change is large.

In order to improve this problem, in the present embodiment, reverse-correcting is performed on dimming brightness information obtained from signal information beforehand and trimming is performed. Then, the processed information is fed back to the image signal side, so that the image is improved.

More particularly, for correcting shoot unbalance, ringing, detail-out, focus error and unnatural noise and the like, brightness correction of the LED backlights is performed. That is, brightness control processing is performed for improving brightness block interference and color block interference.

More specifically, for reducing backlight (luminance) block interference, processing such as block compensation (correction) using backlight, dithering, flexible block control is performed for each block. Also, for reducing color block interference, processing such as color block compensation (correction) using backlight, color dithering, flexible block control is performed for each block.

The above-mentioned flexible control is a control method for controlling the number of blocks and block size. According to the control method, for example, for a backlight unit including 20000 blocks comprising 100 blocks in the vertical direction and 200 blocks in the horizontal direction at the maximum, control can be performed by dividing the backlight unit into 200 blocks (10×20) or control can be performed by dividing the backlight unit to 5000 blocks (100×50), for example. Accordingly, the number of blocks or block size can be changed flexibly.

As mentioned above, in an embodiment, by feeding back brightness control information of backlights to the image, brightness interference to image signals that occur when performing various dimming operations can be improved. Therefore, dimming operation can be made more sophisticated.

As mentioned above, an optimal image that a user can easily watch can be displayed on the display screen, and power consumption can be reduced efficiently. In addition, the apparatus can be realized by a configuration that is simpler than that of the first embodiment.

As mentioned above, according to the present embodiment, an optimal image that a user can easily watch can be displayed on the display screen, and power consumption can be reduced efficiently.

In addition, according to the present embodiment, for example, even though values of APL are the same, a difference between APL 50% having many white components and APL 50% having many black components can be clearly distinguished by the brightness histogram detection, so that optimal backlight control can be performed.

The brightness control method for backlight of the present embodiments can be widely applied to many display apparatuses having backlights such as TV, PC, mobile terminals, and digital cameras and the like.

The present invention is not limited to the specifically disclosed embodiments, and variations and modifications may be made without departing from the scope of the present invention.

What is claimed is:

1. A brightness control apparatus for performing brightness control on backlights for a display screen based on an input image signal, comprising:
an image information analysis unit configured to analyze information of at least one item of an average brightness level, brightness histogram information, color histogram information and frequency histogram information that are obtained from an image frame included in the image signal;
a block information obtaining unit configured to divide the image frame into blocks and to obtain image information for each of the blocks based on an analysis result of the image information analysis unit;
a brightness correction unit configured to perform brightness correction on backlights corresponding to each of the blocks divided by the block information obtaining unit; and
a backlight driving control unit configured to perform driving control of the backlights for each of the blocks based on correction information obtained by the brightness correction unit.

2. The brightness control apparatus as claimed in claim 1, wherein the brightness correction unit performs offset correction and/or non-linear correction for a brightness value of the backlights based on the analysis result obtained by the image information analysis unit.

3. The brightness control apparatus as claimed in claim 1, comprising:
an image correction unit configured to perform correction for the image signal based on brightness correction information for the backlights that is obtained by the brightness correction unit.

4. The brightness control apparatus as claimed in claim 1, wherein the image information analysis unit analyzes an area where brightness change in the image frame is equal to or greater than a predetermined value by using at least one of the average brightness level, the brightness histogram information, the color histogram information and the frequency histogram information.

5. A brightness control method for performing brightness control on backlights for a display screen based on an input image signal, comprising:
an image information analysis step of analyzing information of at least one item of an average brightness level, brightness histogram information, color histogram information and frequency histogram information that are obtained from an image frame included in the image signal;
a block information obtaining step of dividing the image frame into blocks and obtaining image information for each of the blocks based on an analysis result of the image information analysis step;
a brightness correction step of performing brightness correction on backlights corresponding to each of the blocks divided by the block information obtaining step; and
a backlight driving control step of performing driving control of the backlights for each of the blocks based on correction information obtained by the brightness correction step.

6. The brightness control method as claimed in claim 5, wherein the brightness correction step includes:
performing offset correction and/or non-linear correction for a brightness value of the backlights based on the analysis result obtained by the image information analysis step.

7. The brightness control method as claimed in claim 5, comprising:
an image correction step of performing correction for the image signal based on brightness correction information for the backlights that is obtained by the brightness correction step.

8. The brightness control method as claimed in claim 5, wherein the image information analysis step includes:
analyzing an area where brightness change in the image frame is equal to or greater than a predetermined value by using at least one of the average brightness level, the brightness histogram information, the color histogram information and the frequency histogram information.
